(19) United States
(12) Patent Application Publication
(10) Pub. No.: US 2009/0246109 A1
(43) Pub. Date: Oct. 1, 2009

(54) SOLID SOLUTIONS AND METHODS OF MAKING THE SAME

(76) Inventor: Barry W.L. Southward, Catoosa, OK (US)

Correspondence Address: SMITH, GAMBRELL & RUSSELL, SUITE 3100, PROMENADE II, 1230 PEACHTREE STREET, N.E., ATLANTA, GA, 30309-3592, US

(21) Appl. No.: 12/240,170

(22) Filed: Sep. 29, 2008

Related U.S. Application Data
(60) Provisional application No. 61/039,879, filed on Mar. 27, 2008.

(51) Int. Cl. B01D 53/56; B01J 23/10; B01J 23/42; B01J 23/44; B01J 23/46; B01J 27/12; B01J 27/135; B01J 27/13; B01J 27/128; B01J 23/58

(52) U.S. Cl. 423/239.1; 502/303; 502/304; 502/302; 502/339; 502/227; 502/224; 502/230; 502/229; 502/328; 502/330; 502/325

(57) ABSTRACT

A composite single phase crystalline mixed metal oxide NOx scavenger formed of a solid solution, wherein the solid solution has a well defined single phase crystalline structure, as determined by conventional x-ray Diffraction method; and, a NOx scavenger disposed within the single phase oxide structure, without formation of additional X-ray discrete phase, wherein the NOx scavenger is formed from oxides of an element selected from the group consisting of alkali metals, alkaline earth metals, transition metals, rare earth metals and mixtures thereof. The aforementioned single phase oxide may further posses a cubic fluorite structure and said composite cubic oxide NOx scavenger may be advantageously applied to the control of emissions, of both gaseous and solid or particulate nature, from internal combustions especially engines operating under the principle of compression ignition.

### REFERENCES TO A RELATED APPLICATION

This application claims the benefit of copending application 61/039879 filed Mar. 27, 2008, which is relied on and incorporated herein by reference.

### INTRODUCTION AND BACKGROUND

Increasingly stringent emission regulations have led to the introduction of catalytic devices to address both the gases and solid materials emitted as by-products of the internal combustion engine. In the case of the diesel/compression ignition engine these devices include Diesel Oxidation Catalysts (DOC), Diesel NOx Traps (DNT) and Selective Catalytic Reduction catalysts (SCR) to address gaseous emissions while Catalysed Diesel Particulate Filters (CDPF) and Diesel NOx Particulate Traps (DNPT) address the problem of ‘soot’ emissions. All of these technologies typically comprise PGM-containing heterogeneous-phase catalysts containing particles of highly active precious metal (PGM) which are stabilised and dispersed on a refractory oxide support; e.g. alumina, of comparably low intrinsic activity. The DNT and DNPT may additionally contain alkali metal or alkaline earth metal oxides to facilitate regenerative adsorption of Nitrogen Oxides (NOx). Moreover, the CDPF, DNT and DNPT may also contain one or more Oxygen Storage (OS) materials. The OS materials are based on CeO₂ or other redox active oxide and are employed to buffer the catalyst from local variations in the air/fuel ratio during catalyst regeneration or other transient e.g. to limit the ‘slip’ of CO arising from the non-selective oxidation of the carbonaceous matter within the soot. They do this by ‘releasing’ active oxygen from their 3-D structure in a rapid and reproducible manner under oxygen-depleted transients, ‘regenerating’ this lost oxygen by adsorption from the gaseous phase when oxygen-rich conditions arise. This activity is attributed to the reducibility (redox activity) of CeO₂ via the 2Ce⁴⁺→2Ce³⁺[O₂] reaction. In the case of soot interception devices the washcoat may be deposited upon a ‘wall-flow’ monolith which acts to sieve out the bulk of the soot matter from the exhaust flow.

As indicated, some of these catalysts are reliant upon an ‘active’ or forced regeneration cycle, i.e. the manipulation of the gross reactions within the exhaust to facilitate transient switching between oxidising and reducing conditions, for successful operation. In the case of the CDPF the regeneration/combustion of trapped soot particulates is facilitated by the introduction of ‘sacrificial’ fuel species into the exhaust. These species are catalytically oxidised, typically over a diesel oxidation catalyst positioned prior to filter within the exhaust train, to achieve a transient thermal ‘bloom” within the filter which initiates the conversion of the trapped soot into CO₂ and H₂O. Similarly for the DNPT the trapped soot and also NOₓ are again converted into environmentally benign products (N₂, CO₂ and H₂O) by the introduction of ‘sacrificial’ fuel species into the exhaust to initiate the conversion of soot and simultaneously the reduction of the trapped NOx to N₂ during transient ‘rich’ condition present at this time.

However, the combustion of sacrificial hydrocarbon species to produce the thermal bloom required for regeneration imposes a substantial and unattractive fuel penalty; namely, an additional and ongoing operational cost. Moreover, the implementation of an active emissions control strategy requires complex and accurate engine management protocols to avoid incomplete regeneration and/or untreated emissions. In addition, soot combustion initiated in this manner results in a phenomenon known as ‘oil dilution’ which results in ash deposition (inorganic salts) within the filter which impact the back pressure, soot capacity and catalytic performance of the filter. Finally, it is known that active regeneration proceeds in a more homogeneous; i.e. non-catalytic manner and can lead to uncontrolled regeneration. This, in turn, can result in localized exothermic ‘hotspots’ of extreme temperature (T≧1000° C.) which can easily damage the physical attributes of the formulation required for high catalytic efficiency, e.g. PGM sintering, surface area/porosity collapse. In the worst case, catastrophic uncontrolled combustion of soot can destroy the monolith through thermal degradation or even melting of the monolith.

Additionally the use of specific molecular salts based upon barium, potassium, etc. typically employed to facilitate regenerable NOx trapping is also unattractive given a generic issue with ‘effectiveness’ of the trapping component due to its low dispersion, which both limits the total NOx capacity and increases problems associated with SOx uptake and retention. In addition, barium presents specific issues with respect to toxicity and contamination while potassium is known to poison the PGM function, displays high mobility during exhaust conditions and can also react with the substrate material, in the case of cordierite, and thus compromises the integrity substrate.

Many attempts have been made to address or limit the extent of the issues related to the active regeneration strategy. Such efforts are exemplified by attempts to introduce passive regeneration strategies based upon the use of the redox chemistry of advanced OS materials, e.g. US published application 2005/0282698 A1. This methodology attempts to decrease the temperature required for soot oxidation by utilisation of active oxygen species derived from a redox active washcoat material, typically Ce—Zr-based Cubic Fluorite solid solution. However, attempts to employ this methodology in vehicular applications have met with limited success. Extensive studies of the chemistry occurring in these systems have demonstrated that the activity of the OS-based catalyst is dependent upon high ‘Contact Efficiency’ between the OS material and the soot, e.g. see, Applied Catalysis B. Environmental 8, 57, (1996). Subsequent studies, described in SAE paper 2008-01-0481 have now identified that the loss of contact efficiency between the OS and soot arises from specific chemistries involving the significant NO engine emissions typical of pre-EuroV legislation engines. This process has been denoted as ‘de-coupling’ of the OS and soot and is the result of the reaction of engine out NO over oxidized PGM to produce NO₂ which combusts the soot in the immediate environment of the catalyst producing CO +NO. The NO byproduct of this process is further ‘recycled’ to NO₂ and the soot combustion re-initiated, again removing only that soot which immediately contacts the catalyst. This cycle is the basis of U.S. Pat. No. 4,902,487 and previously believed to be the major reaction providing low temperature soot combustion/regeneration. However, this mechanism is only effective at removing low concentrations of soot and indeed only that proportion of soot in direct contact with the catalyst. Hence, this mechanism effectively ‘de-couples’ the catalyst and soot and dramatically decreases the effectiveness of the OS-mediated regeneration method and may in fact be considered to be a reactive poison which effectively ‘deactivates’ the ‘true’ OS mediated low temperature, passive, soot regeneration reaction required for optimum soot emission control.

Hence, none of the above methods provide a truly effective means for addressing both engine out NO emissions and their deleterious effects on exhaust abatement catalysts. What is required is a new class of OS-derived materials tailored to additionally and specifically address the issues relating to the impact of NOx-chemistry and contact efficiency between catalyst and soot.

Solid electrolytes based on Zirconia (ZrO₂), thorium (ThO₂), and ceria (CeO₂) doped with lower valent ions have been extensively studied, for examples see U.S. Pat. No. 6,585,944 and U.S. Pat. No. 6,387,338. The introduction of lower valent ions, such as rare earths (yttrium (Y), lanthanum (La), neodymium (Nd), dysprosium (Dy), and the like) and alkaline earths (strontium (Sr), calcium (Ca), and magnesium (Mg)), results in the formation of oxygen vacancies in order to preserve electrical neutrality. The presence of the oxygen vacancies in turn gives rise to oxygen ionic conductivity (OIC) at high temperatures (e.g., greater than 800° C.). Typical commercial or potential applications for these solid electrolytes includes their use in solid oxide fuel cells (SOFC) for energy conversion, oxygen storage (OS) materials in three-way-conversion (TWC) catalysts, electrochemical oxygen sensors, oxygen ion pumps, structural ceramics of high toughness, heating elements, electrochemical reactors, steam electrolysis cells, electrochromic materials, magnetohydrodynamic (MHD) generators, hydrogen sensors, catalysts for methanol decomposition and potential hosts for immobilizing nuclear waste.

As used herein, the term ‘rare earth’ means the 30 rare earth elements composed of the lanthanide and actinide series of the Periodic Table of Elements.

Both CeO₂ and ThO₂ solid electrolytes exist in the cubic crystal structure in both doped and undoped forms. In the case of doped ZrO₂, partially stabilized ZrO₂ consists of tetragonal and cubic phases while the fully stabilized form exists in the cubic fluorite structure. The amount of dopant required to fully stabilize the cubic structure for ZrO₂ varies with dopant type. For Ca it is in the range of about 12-13 mole %, for Y₂O₃ and Sc₂O₃ it is greater than about 18 mole % of the Y or scandium (Sc), and for other rare earths (e.g., Yb₂O₃, Dy₂O₃, Gd₂O₃, Nd₂O₃, and Sm₂O₃) it is in the range of about 16-24 mole % of ytterbium (Yb), Dy, gadolinium (Gd), Nd, and samarium (Sm).

Solid solutions consisting of ZrO₂, CeO₂ and trivalent dopants are used in three-way-conversion (TWC) catalysts as oxygen storage (OS) materials and are found to be more effective than pure CeO₂ both for higher oxygen storage capacity and in having faster response characteristics to air-to-fuel (A/F) transients. In the automotive industry there is also great interest in developing lower temperature and faster response oxygen sensors to control the A/F ratio in the automotive exhaust. Additionally, reports concerning the use of ceria-based catalysts for soot oxidation (US 2005/0282698 A1) reveal new uses for solid solutions of CeO₂ with other elements where low temperature Ce⁴⁺⇄Ce³⁺ redox activity may have significant importance.

Oxygen storage (OS) in exhaust catalyst applications arises due to the nature of the Ce⁴⁺⇄Ce³⁺ redox cycle in typical exhaust gas mixtures. Benefits of yttrium and other rare earth doped CeO₂—ZrO₂ solid solutions compared to undoped CeO₂ and CeO₂—ZrO₂ for TWC catalyst applications is due to improved Ce⁴⁺ reducibility at relatively low temperatures and enhanced oxygen ion conductivity (OIC), i.e., mobility of oxygen in the oxygen sublattice. These characteristics of the above mentioned solid solutions make them efficient in providing extra oxygen for the oxidation of hydrocarbons (HC) and carbon monoxide (CO) under fuel rich conditions when not enough oxygen is available in the exhaust gas for complete conversion to carbon dioxide (CO₂) and water (H₂O). Solid solutions with substantially cubic structures were found to have advantages over other crystal structures, and are used herein as host matrices as shown in U.S. Pat. No. 6,585,944 and U.S. Pat. No. 6,387,338, the entire disclosures of which are relied on and incorporated herein by reference.

It is acknowledged that CeO₂, and to a lesser extent ThO₂, based systems are preferentially acknowledged as active redox couple systems. However for the purposes of this application the term ‘redox active’ could equally apply to any metal oxide or mixed metal oxide system that undergoes oxidation-reduction during normal vehicular operation conditions. The metal oxide/mixed metal oxide can provide or accept electrons under the exhaust temperature/composition regimes that are generated during catalyst operation.

The OS/OIC function is significantly enhanced by platinum group metals (PGM) such as palladium (Pd), platinum (Pt), and rhodium (Rh). In the presence of these precious metals, the reduction of the Ce⁴⁺ to Ce³⁺ in doped CeO₂—ZrO₂ solid solutions occurs at lower temperatures and improves TWC catalyst efficiency in reducing HC, CO, and nitrogen oxides (NOx) pollutants.

Oxygen storage (OS) materials are also employed in diesel-based exhaust treatment applications such as Catalysed Diesel Particulate Filters (CDPFs), Diesel NOx Traps (DNTs), and Diesel NOx Particulate Traps (DNPTs) to convert undesirable constituents of the exhaust stream into less undesirable molecules. This is achieved by disposing the OS onto a substrate comprising high surface area in conjunction with NOx storage materials and precious metal catalysts. The OS and NOx storage materials absorb oxygen and NOx from the diesel exhaust, respectively, which is generally oxidizing (e.g., lean or oxygen rich). Thereafter, the exhaust stream can be temporarily changed to a fuel rich (e.g., oxygen poor) environment, as described previously, to promote the conversion of the undesirable constituents. The exhaust stream is changed to a fuel rich environment via active regeneration systems. Active regeneration systems employ an exhaust stream monitoring component and a fuel injection component that are jointly employed to produce the fuel-rich transient environment by injecting diesel fuel into the exhaust stream when directed by exhaust conditions. The fuel rich environment produced promotes the release of trapped nitrates as NOₓ and also promotes the release of oxygen from the OS, which then catalytically react, in the presence of an appropriate catalytic metal e.g. Rh or Pd, with CO and H₂ present in the exhaust stream to form CO₂, H₂O, and N₂. The thermal transient produced initiates the combustion in the case of the CDPF or DNPT.

Although active regeneration systems are generally effective at reducing the amount of NOx emissions, these systems are expensive, increase fuel consumption, are susceptible to sulfur poisoning, and generally inefficient at scavenging NOx with respect to NOx adsorber loading. In addition, active regeneration systems also exhibit several manufacturing related shortcomings, such as, poor dispersion of NOx adsorber materials and high catalyst loadings. And the NOx adsorbers employed can be toxic or strong oxidizers (e.g., barium nitrates and potassium nitrates, respectively). Yet, even further, active regeneration systems are incapable of reducing NOx emissions and soot at low operating temperatures, such as, during start-up conditions where a bulk of emissions are released into the environment.

New emission regulations impose stringent requirements on NOx and soot emissions (e.g., Euro V). Therefore, interest in improved exhaust treatment systems is increasing. Active regeneration systems employing urea or ammonia injection are being researched as well as other systems. However, these technologies will comprise many of the shortcomings discussed above, such as high initial expense, complexity, high operating costs, and so forth.

What is additionally needed in the art are improved exhaust treatment systems, or more specifically, passive exhaust treatment materials that can introduce, enhance and specifically tailor the transient NOx scavenging characteristics of material components in order to disable the ‘De-Coupling’ of Soot and OS contact engendered by NO₂ based soot oxidation mechanism. Such a material would advantageously provide improved efficiency with regards to NOx trapping function or equal NOx trapping function at a reduced decreased concentration in the washcoat. It would also exhibit a lower susceptibility to sulfur poisoning and decreased temperature required for desorption of said Sulfur-derived poisons thereby enhancing overall catalytic function.

### SUMMARY OF THE INVENTION

Disclosed herein are cerium-oxide exhaust treatment materials, articles employing said materials, as well as methods for making and using the same. More particularly, the present invention relates to a NOx adsorber comprising a solid solution, wherein the solid solution comprises a cubic fluorite structure as determined by conventional x-ray diffraction method; and, a NOx scavenger disposed within the cubic fluorite structure, wherein the NOx scavenger is formed from oxides, and the oxides thereof are formed from an element, or an oxide of an element, selected from the group consisting of alkali metals, alkaline earth metals, transition metals and mixtures thereof.

The cubic fluorite structure comprises a material selected form the group consisting of ceria, zirconia, thorium and mixtures thereof. A stabiliser can also be included, preferably a metal or metal oxide. The metal of stabilisers is, one or more elements selected from the group of rare earths consisting of scandium (Sc), yttrium (Y), lanthanum (La), cerium (Ce), praseodymium (Pr), neodymium (Nd), promethium (Pm), samarium (Sm), europium (Eu), gadolinium (Gd), terbium (Th), dysprosium (Dy), holmium (Ho), erbium (Er), thulium (Tm), ytterbium (Yb), lutetium (Lu) and mixtures thereof. Preferably, the metal oxide is a rare earth metal oxide.

In a further aspect of the present invention, the composite OS—NOx adsorber, further comprises a catalytic metal selected from the group comprising platinum, palladium, iridium, silver, rhodium, ruthenium and mixtures thereof.

The solid solution of a substantially cubic fluorite structure of the NOx absorber is preferably cerium oxide or zirconium oxide or mixtures thereof.

In another aspect of the present invention, the solid solution of a substantially cubic fluorite structure contains a highly dispersed NOx scavenger. The NOx scavenger is incorporated within the structure of the oxygen storage material, without forming any discrete phases detectable by conventional X-Ray Diffraction method, is a metal or metal oxide capable of forming nitrates at temperatures that are less than or equal to about 200° C., preferably less than or equal to about 300° C. and more preferably greater than about 400° C., and capable of reducing the nitrates at temperatures that are greater than about 200° C., preferably greater than about 300° C., and more preferably greater than about 400° C.

In another embodiment of the invention, there is provided a composite catalyst comprising a NOx adsorber including a solid solution, wherein the solid solution comprises a cubic fluorite structure; and, a NOx scavenger disposed within the cubic fluorite structure, wherein the NOx scavenger is formed from oxides, wherein the oxides comprise an element selected from the group consisting of alkali metals, alkaline earth metals, transition metals and mixtures thereof; and a platinum group metal deposited on said NOx adsorber.

According to this embodiment, the cubic fluorite structure comprises a material selected from the group consisting of ceria, zirconia, thorium and mixtures thereof. A stabiliser, such as a metal or metal oxide, can also be added to the composite catalyst.

In this embodiment, the platinum/precious group metal is a catalytic metal selected from the group comprising platinum, palladium, iridium, silver, rhodium, ruthenium and mixtures thereof. The composite catalyst can also include an oxygen storage material such as cerium oxide or zirconium oxide and mixtures thereof.

The composite catalyst of this invention can be deposited by conventional means and methods on any suitable inert carrier which are well known in the art. Preferably, an inert ceramic or metal honeycomb carrier can be used. Pellets of an inert material can also be used as the carrier. Any suitable conventional housing or canister can be used to retain the composite catalyst of the present invention.

The above described and other features will be appreciated and understood from the following detailed description, drawing, and appended claims.

### BRIEF DESCRIPTION OF DRAWINGS

FIG. 1 is a graph illustrating the impact of ‘Contact Efficiency’ on the ‘direct’ catalytic oxidation of artificial soot analogue (Printex U) by conventional Cubic Fluorite—based CeZr solid solution/mixed oxide. OS1-44% CeO₂, 42% ZrO₂, 9.5% La₂O₃, 4.5% Pr₆O₁₁;

FIG. 2 is a graph illustrating the impact of engine soot loading conditions on the catalytic performance of a conventional Pt—OS1-Al₂O₃ washcoat for the direct catalytic soot oxidation as examined in a synthetic gas bench (SGB) ‘burn-out’ experiment;

FIG. 3 is a graph referring to the SGB temperature programmed reaction profile of the reaction of an intimate mixture of 0.75% Pt—Al₂O₃—OS1: Printex U (4:1) in the presence of 100 ppm NO;

FIG. 4 is a graph of the SGB temperature programmed reaction profile of the reaction of an intimate mixture of 0.75% Pt—Al₂O₃—OS1: Printex U (4:1) in the absence of NO;

FIG. 5 is the X-Ray Diffraction patterns for OS2 (Δ) and OS3 (O),

OS2 34% CeO₂, 42% ZrO₂, 9.5% Nd₂O₃, 4.5% Pr₆O₁₁, 10% SrO,

OS3 44% CeO₂, 32% ZrO₂, 9.5% Nd₂O₃, 4.5% Pr₆O₁₁, 10% SrO;

FIG. 6 is a graph of the SGB temperature programmed reaction profile of the reaction of an intimate mixture of 0.75% Pt—Al₂O₃—OS₂: Printex U (9:1); Key: X—CO conversion, +−HC conversion, * −NO₂ make, ▾−bed temperature.

FIG. 7 is a graph of the SGB temperature programmed reaction profile of the reaction of an intimate mixture of 0.75% Pt—Al₂O₃—OS3: Printex U (9:1); Key: X—CO conversion, +−HC conversion, * −NO₂ make, ▾−bed temperature

FIG. 8 illustrates the XRD patterns for OS4 (□) and OS5 (O);

OS4 34% CeO₂, 42% ZrO₂, 9.5% Nd₂O₃, 4.5% Pr₆O₁₁, 10% SrO,

OS5 44% CeO₂, 32% ZrO₂, 9.5% Nd₂O₃, 4.5% Pr₆O₁₁, 10% SrO;

FIG. 9 is a graph referring to the ‘fresh’ NO₂ storage and release for OS4 and OS5 materials using 2% Pt and 2% Pd promoted materials;

FIG. 10 is a graph referring to the ‘aged’ NO₂ storage and release for OS4 and OS5 materials using 2% Pt and 2% Pd promoted materials;

FIG. 11 shows the SGB performance of an intimate mixture of 2% Pt—Al₂O₃—OS4: Printex U (9:1);

FIG. 12 depicts the SGB temperature programmed reaction profile of the reaction of an intimate mixture of 2% Pt—Al₂O₃—OS5: Printex U (9:1);

FIG. 13 records the XRD patterns for OS6 (□) and OS7 (O),

OS6 31.5% CeO₂, 53.5% ZrO₂, 5% La₂O₃, 5% Y₂O₃, 5% SrO

OS7 39% CeO₂, 42% ZrO₂, 9.5% La₂O₃, 4.5% Pr₆O₁₁, 5% SrO;

FIG. 14 illustrates the SGB temperature programmed reaction profile of the reaction of an intimate mixture of 0.75% Pt—Al₂O₃—OS6: Printex U (9:1);

FIG. 15 is a graph of the SGB temperature programmed reaction profile of the reaction of an intimate mixture of 0.75% Pt—Al₂O₃—OS7: Printex U (9:1);

FIG. 16 shows the SGB temperature programmed reaction profiles of the reaction of a) an intimate mixture of 0.75% Pt—Al₂O₃—OS7: Printex U (9:1) versus b) an intimate mix of 0.75% Pt—Al₂O₃—OS1 impregnated with 10% SrO: Printex U (9:1);

FIG. 17 is a table of the CO light-off, Temperature of peak rate of soot combustion and CO slip during soot combustion for 0.75% Pt—Al₂O₃—OS systems for OS7, OS1+10% SrO, OS1+10% K₂O or OS1+10Ag₂O; and

FIG. 18 shows the Temperature of peak soot combustion and XRD characteristics for composite OS—NOx scavengers containing a CaO NOx scavenger.

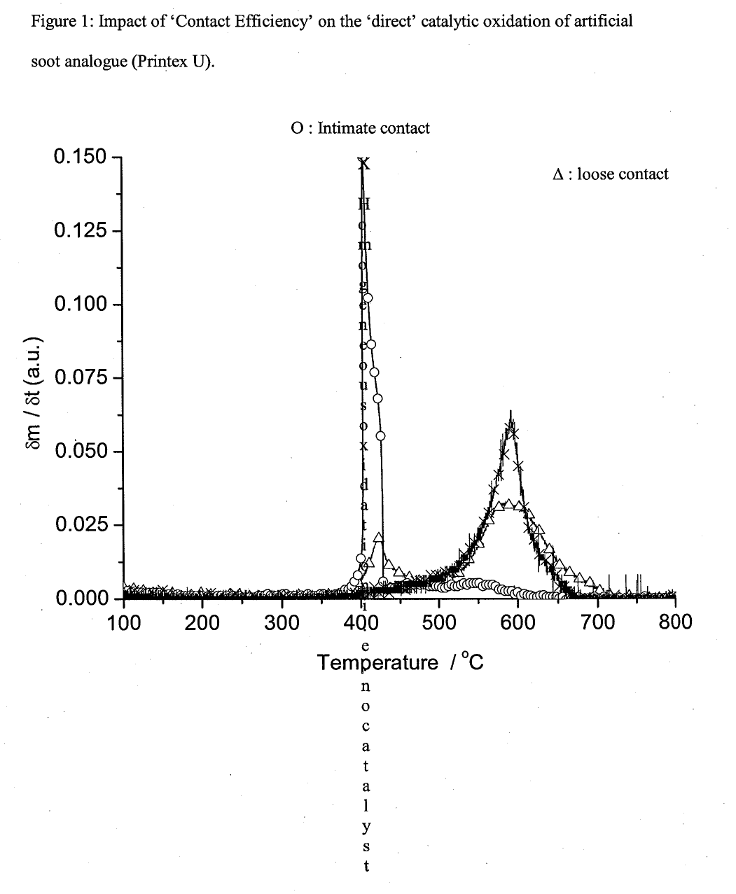

OS8 44% CeO₂, 39.5% ZrO₂, 9.5% La₂O₃, 4.5% Pr₆O₁₁, 2.5% CaO

OS9 44% CeO₂, 39.5% ZrO₂, 9.5% La₂O₃, 4.5% Y₂O₃, 2.5% CaO

### DETAILED DESCRIPTION

Disclosed herein are composite OS/NOx adsorber solid solutions and exhaust gas treatment devices comprising the same. To be more specific, the composite OS—NOx storage materials are disclosed that comprise a substantially cubic structure; e.g., Fluorite structure as determined by conventional x-ray diffraction method, having a NOx scavenger incorporated therein. The resulting composite cubic NOx adsorber is capable of adsorbing NOx and forming a nitrate that can decompose under normal operating temperatures of the exhaust stream to release NOx.

For the purposes of this invention, the OS/redox active system are previously defined (e.g. see US published application 2005/0282698 which is relied on and incorporated herein by reference) and consist of any metal oxide or mixed metal oxide system that undergoes oxidation—reduction under the normal vehicle operating conditions; i.e. exhaust compositions that are generated during catalyst operation. A specific example would include CeO₂ which can undergo reduction—oxidation under these exhaust cycling conditions and that the redox cycling of Ce is greatly enhanced via fonnation of solid solutions with ZrO₂ and rare earths such as La₂O₃, Y₂O₃, Pr₆O₁₁, Nd₂O₃, etc. However, other elements can also be beneficially included in the OS material, e.g. Fe, Mn, Nb, Ta, Sm etc. The most effective compositions are believed to be solid solutions with CeO₂ as the primary redox active component and lower levels of other elements added to promote Ce reduction, e.g. Mn.

In general, the OS materials described herein are conventional binary, tertiary, quaternary, etc. compositions based on CeZr solid solutions containing a substantially phase pure Cubic Fluorite lattice (as determined by conventional X-Ray Diffraction (XRD) method).

However, in this instance the role of the OS material is augmented by inclusion of a specific, and highly dispersed, component to facilitate NOx transient scavenging and/or regenerable adsorption. The NOx scavenger is preferentially added during the conventional co-precipitation synthesis process and may include any metal (or metal oxide) capable of introducing NOx scavenging function; e.g. Group I the alkali metals, Group II the alkaline earth metals or transition metals. That is, appropriate elements for this application include, but are not limited to, alkali metals, e.g. Na, K, alkaline Earth Metals, e.g. Mg, Ca, Sr or transition metal known to form a stable nitrate which undergoes decomposition under conditions within the conventional operational window of the vehicle exhaust. By the term ‘transition metals’, we mean the 38 elements in Groups 3 through 12 of the Periodic Table of Elements.

The composite OS cubic NOx scavengers described herein differ significantly from conventional NOx adsorbers employed to date in that they do not employ a conventional bulk oxide e.g. alkali metal, alkaline earth metal etc. but rather provide NOx functionality by the use of specifically engineered composite crystal structures. However, the mechanism by which the composite cubic OS NOx scavenger functions is generally comparable i.e. the trapping NOx on surface atoms of the oxide as a nitrate salt during fuel-lean conditions, followed by decomposition and reduction to N₂ in fuel-rich transients. Hence, the composite cubic OS—NOx scavenger can be employed in catalysts for exhaust gas treatment applications. For example, a catalyst system can employ a precious metal catalyst (e.g., Pt, Rh, and other platinum group metals) to react the released NO and NO₂ to form less undesirable emissions, such as CO₂, O₂ and N₂.

The NOx scavenger can be defined as any bulk metal oxide or metal salt capable of forming a stable nitrate under the conditions existing in a Diesel I.C.E. exhaust. To be more specific, the composite cubic NOx scavenger is capable of forming nitrates at temperatures that are less than or equal to about 200° C. and reducing the nitrates at temperatures that are greater than about 200° C., or more specifically, less than or equal to about 300° C. and greater than about 300° C., and even more specifically, less than or equal to about 400° C. and greater than about 400° C.

Also, the NOx scavenger can be defined as any bulk/surface nitrate which may be regenerably decomposed to its prior oxide or salt under the conditions existing during the active regeneration cycle of the catalysed Diesel particulate filter.

Other preferred elements include those of the Group IB (Copper family), e.g. Cu, Ag, Au, with Ag being demonstrated as having a particular efficacy for this NOx scavenging function (e.g. see SAE paper 2008-01-0481). At this time this list is not exhaustive and it is envisioned that any metal or metalloid element capable of forming nitrates/nitrites stable under conventional ‘cold start’ diesel exhaust temperatures but which readily decompose below 500° C., may also be appropriate for this purpose.

One particular benefit of composite cubic NOx scavengers is that these materials provide an intrinsically far higher dispersion of trapping component than non-cubic, i.e. conventional, impregnation-type NOx adsorbers. As a result, the efficiency of NOx storage per mol. % of the NOx adsorbing material is greater for the composite cubic NOx material than non-cubic NOx adsorbers. Therefore, less material is employed during manufacture, which decreases production costs and provides for reduced backpressure during operation, thereby improving engine performance and efficiency. This higher capacity provides further benefit since it will allow the vehicle to run longer under ‘lean’ conditions without the tailpipe NOx (NOx slip) exceeding permitted values before requiring the rich regeneration cycle. This means fewer regeneration cycles per 1000 km; i.e. lower fuel penalty/decreased operational cost.

Another particular benefit of the cubic NOx adsorbers compared to the non-cubic NOx adsorbers is that when sulfur is trapped within the NOx adsorber lattice, unstable sulfides are formed, due to their high atomic dispersion and thus, higher surface energy, which enable for the lower temperature desulfation of the cubic NOx adsorber.

A further especial benefit of the composite cubic OS—NOx adsorber is its ability to facilitate lower temperature particulate combustion. This is achieved for the CDPF/DNPT, since the composite materials disable the de-coupling mechanism of NO₂, thereby retaining higher contact efficiency between the catalyst and soot (as described in SAE paper 2008-01-0481) and this, in turn, enables the catalyst to provide an active and direct mechanism for soot oxidation, thereby decreasing the temperature required during the regeneration cycle to achieve complete soot burn—again, an operating cost saving due to decreased fuel penalty (and decreased ash deposition, oil dilution, etc.)

The solid solution can comprise the cubic NOx adsorber and additional components, such as stabilisers, catalysts, oxygen storage components and other additives contributing their expected function. In such solid solutions, the NOx adsorber can be present in an amount of about 0.01 mol % to about 25 mol %, or more specifically, about 0.1 mol % to about 15 mol %, or, even more specifically about 0.5 mol % to about 10 mol %, and yet more specifically, about 1 mol % to about 5 mol %.

Stabilisers can be employed within the solid solution to alter the properties and/or function of the NOx adsorber. The stabilizer can be metals and/or metal oxides. Exemplary metals are the rare earths and comprise scandium (Sc), yttrium (Y), lanthanum (La), cerium (Ce), praseodymium (Pr), neodymium (Nd), promethium (Pm), samarium (Sm), europium (Eu), gadolinium (Gd), terbium (Th), dysprosium (Dy), holmium (Ho), erbium (Er), thulium (Tm), ytterbium (Yb), lutetium (Lu) and mixtures thereof. For example, La and Y can be present in the solid solution; in another example, the stabilizer can comprise yttrium and a rare earth metal. Exemplary oxides are rare earth oxides, such as La₂O₃, Y₂O₃, Pr₆O₁₁, Nd₂O₃, and the like. For example, rare earth oxide stabilisers can enhance the reduction of the NOx from a cerium oxide lattice. To be more specific, stabilisers can be present in the solid solution in amounts that are less than or equal to about 20 mol %, or more specifically, about 0.5 mol % to about 15 mol %, or, even more specifically about 5 mol % to about 15 mol %.

Catalytic metals can be employed within the solid solution to reduce the NOx released by the cubic NOx adsorber to NO. Exemplary catalytic metals comprise transition metals (e.g., Pt, Rh, Ru, Pd, Ag, and the like).

The concentration of the components employed to form the cubic NOx adsorber or solid solution can be tailored to modify the properties thereof. For example, a sufficient amount of zirconium can be employed in a solid solution to minimize the reduction energies of Ce⁴⁺ and minimize activation energy so as to provide enhanced mobility of oxygen within the lattice.

Additional oxygen storage materials can be added to the solid solution to provide an oxygen storage function. Exemplary oxygen storage materials are CeO₂ and ZrO₂. To be more specific, a solid solution can comprise less than or equal to about 95 mole percent (mol %), or more specifically about 30 mol % to about 90 mol %, or even more specifically about 50 mol % to about 85 mol % zirconium, less than or equal to about 50 mol %, or more specifically about 0.5 mol % to about 45 mol %, or even more specifically about 5 mol % to about 40 mol % cerium. In one embodiment, a catalyst system can be formed wherein a solid solution comprises a cubic NOx adsorber, an oxygen storage material, and catalytic metals.

The solid solution has a substantially cubic crystal structure, particularly a cubic fluorite crystal structure as characterized by powder X-ray diffraction (XRD) analysis of the cation sublattice, even for compositions that have in excess of 50 mole percent (mol %) zirconium.

A composite cubic OS—NOx scavenger or a solid solution comprising a cubic NOx adsorber can be employed in an exhaust gas treatment device, e.g., disposed on/in an inert substrate or carrier. Exhaust gas treatment devices can generally comprise housing or canister components that can be easily attached to an exhaust gas conduit and comprise a substrate for treating exhaust gases. The housing components can comprise an outer ‘shell’, which can be capped on either end with funnel-shaped ‘end-cones’ or flat ‘end-plates’, which can comprise ‘snorkels’ that allow for easy assembly to an exhaust conduit. Housing components can be fabricated of any materials capable of withstanding the temperatures, corrosion, and wear encountered during the operation of the exhaust gas treatment device, such as, but not limited to, ferrous metals or ferritic stainless steels (e.g., martensitic, ferritic, and austenitic stainless materials, and the like).

Disposed within the shell can be a retention material (‘mat’ or ‘matting’), which is capable of supporting a substrate, insulating the shell from the high operating temperatures of the substrate, providing substrate retention by applying compressive radial forces about it, and providing the substrate with impact protection. The matting is typically concentrically disposed around the substrate forming a substrate/mat sub-assembly.

Various materials can be employed for the matting and the insulation. These materials can exist in the form of a mat, fibres, preforms, or the like, and comprise materials such as, but not limited to, intumescent materials (e.g., a material that comprises vermiculite component, i.e., a component that expands upon the application of heat), non-intumescent materials, ceramic materials (e.g., ceramic fibers), organic binders, inorganic binders, and the like, as well as combinations comprising at least one of the foregoing materials. Non-intumescent materials include materials such as those sold under the trademarks ‘NEXTEL’ and ‘INTERAM 1101HT’ by the ‘3M’ Company, Minneapolis, Minn., or those sold under the trademark, ‘FIBERFRAX’ and ‘CC-MAX’ by the Unifrax Co., Niagara Falls, N.Y., and the like. Intumescent materials include materials sold under the trademark ‘INTERAM’ by the ‘3M’ Company, Minneapolis, Minn., as well as those intumescent materials which are also sold under the aforementioned ‘FIBERFRAX’ trademark.

Substrates or carriers can comprise any material designed for use in a spark ignition or diesel engine environment having the following characteristics: (1) capability of operating at temperatures up to about 600° C. and up to about 1,000° C. for some applications, depending upon the device's location within the exhaust system (e.g., manifold mounted, close coupled, or underfloor) and the type of system (e.g., gasoline or diesel); (2) capability of withstanding exposure to hydrocarbons, nitrogen oxides, carbon monoxide, particulate matter (e.g., soot and the like), carbon dioxide, and/or sulfur; and (3) have sufficient surface area and structural integrity to support a catalyst, if desired. These materials should be inert under the conditions imposed on them when in use. Some possible materials include cordierite, silicon carbide, metal, metal oxides (e.g., alumina, and the like), glasses, and the like and mixtures comprising at least one of the foregoing materials. Some suitable inert ceramic materials include ‘Honey Ceram’, commercially available from NGK-Locke, Inc, Southfield, Mich., and ‘Celcor’, commercially available from Coming, Inc., Corning, N.Y. These materials can be in the form of foils, perform, mat, fibrous material, monoliths (e.g., a honeycomb structure, and the like), other porous structures (e.g., porous glasses, sponges), foams, pellets, particles, molecular sieves, and the like (depending upon the particular device), and combinations comprising at least one of the foregoing materials and forms, e.g., metallic foils, open pore alumina sponges, and porous ultra-low expansion glasses. Furthermore, these substrates can be coated with oxides and/or hexaaluminates, such as stainless steel foil coated with a hexaaluminate scale.

Although the substrate can have any size or geometry, the size and geometry are preferably chosen to optimise surface area in the given exhaust gas emission control device design parameters. Typically, the substrate has a honeycomb geometry, with the combs through-channel having any multi-sided or rounded shape, with substantially square, triangular, pentagonal, hexagonal, heptagonal, or octagonal or similar geometries preferred due to ease of manufacturing and increased surface area.

The exhaust gas treatment devices can be assembled utilizing various methods. Three such methods are the stuffing, clamshell, and tourniquet assembly methods. The stuffing method generally comprises pre-assembling the matting around the substrate and pushing, or stuffing, the assembly into the shell through a stuffing cone. The stuffing cone serves as an assembly tool that is capable of attaching to one end of the shell. Where attached, the shell and stuffing cone have the same cross-sectional geometry, and along the stuffing cone's length, the cross-sectional geometry gradually tapers to a larger cross-sectional geometry. Through this larger end, the substrate/mat sub-assembly can be advanced which compresses the matting around the substrate as the assembly advances through the stuffing cone's taper and is eventually pushed into the shell.

Exhaust gas treatment devices comprising the cubic NOx adsorber or solid solutions comprising cubic NOx adsorbers can be employed in exhaust gas treatment systems to provide a NOx adsorption function, or more specifically to reduce a concentration of undesirable constituents in the exhaust gas stream. For example, as discussed above, an exemplary catalyst system can be formed utilizing a cubic NOx adsorber, a catalyst(s), and an oxygen storage material, wherein the catalyst system is disposed on a substrate, which is then disposed within a housing. Disposing the substrate to an exhaust gas stream can then provide at least a NOx storage function, and desirably even reduce the concentration of at least one undesirable constituent contained therein.

According to one embodiment of the present invention, a CDPF or DNPT can comprise a porous substrate having alternating channels. The alternating channels comprise upstream channels and downstream channels, which both have an upstream end and a downstream end. The upstream channels are configured such that its upstream end is open and allows exhaust gas to flow therethrough. The downstream end of the upstream channels is blocked, which does not allow exhaust gas to flow therethrough. The downstream channels are configured such that its upstream end is blocked, which does not allow exhaust gas to flow therethrough. The downstream end of the downstream channels is open, which allows exhaust gas to flow therethrough. In use, the exhaust gas flowing from the upstream channels passes through the walls of the substrate to the downstream channels. A solid solution can be dispersed within the upstream channels and downstream channels, and possibly within the substrate (e.g., depending upon the application method, porosity of the substrate, the size of the solid solution granules, and other variables).

One particular benefit of cubic NOx adsorbers is that these materials provide an intrinsically far higher dispersion of trapping component than non-cubic NOx adsorbers. As a result, the efficiency of NOx storage per mol % of the NOx adsorbing material is greater for the cubic NOx adsorber than non-cubic NOx adsorbers. Therefore, less material is employed during manufacture, which decreases production costs and provides for reduced backpressure during operation, thereby improving engine performance and efficiency.

Another particular benefit of the composite cubic OS—NOx scavenger compared to the non-cubic NOx adsorbers is that when sulfur is trapped within the NOx adsorber lattice, unstable sulfides are formed, due to their high atomic dispersion and thus, higher surface energy, which enable for the lower temperature desulfation of the cubic NOx adsorber.

### Working Examples:

The importance of contact efficiency between catalyst and soot was examined using Thermogravimetric Analysis/TGA using a Perkin Elmer TGA7 with a ramp rate 10° C./min in air purge of 20 ml/min. The study contrasted the performance of homogeneous soot oxidation (using Printex U, a low soluble organic fraction (SOF) soot analogue from Degussa A.G.) with soot oxidation in the presence of a conventional mixed oxide/Oxygen Storage (OS1) under conditions of ‘loose’ (mixed by spatula) and ‘tight’ or intimate contact (mix-milled in paint shaker for 15 minutes). The data clearly confirms that the pre-requisite for efficient direct soot combustion catalysis is high contact efficiency, in agreement with previous studies (see for examples Applied Catalysis B. Environmental 8, 57, 1996 and Applied Catalysis B. Environmental 12, 21, 1997). The sharp response in the case of good contact is ascribed to a manifestation of a thermal cascade process arising from the specific mass and heat transfer phenomena present with the TGA. However, in the case of loose contact the Tmax (temperature of maximum rate of soot combustion) increases from 405° C. to 590° C. Moreover, comparison of the shape of the three responses is telling; in the case of loose contact there is bi-modal combustion profile reflecting the presence of limited domains of higher contact (peak at ca. 410° C.) and large areas of practically zero contact, which correspond well to homogeneous combustion, albeit promoted by the exotherm generated by the tight contact combustion process.

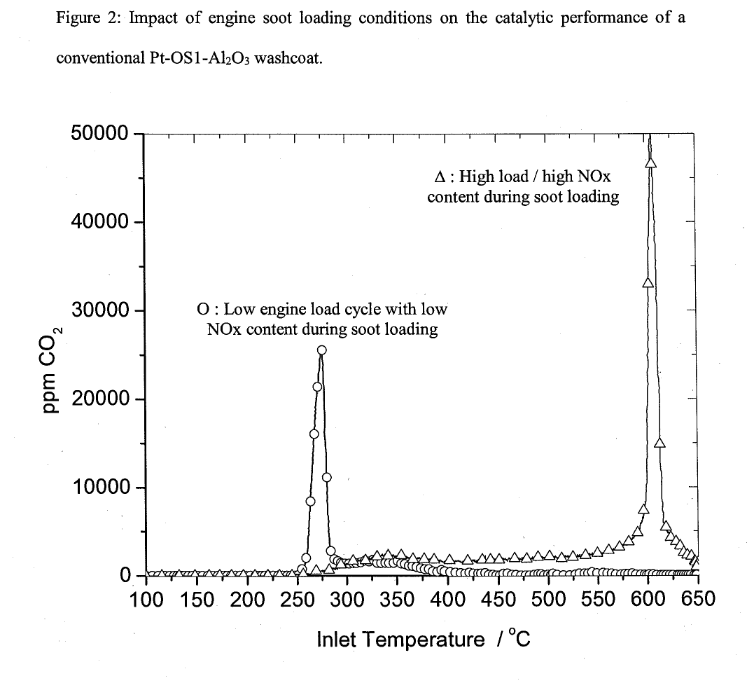

The importance of direct contact is further evident in FIG. 2 which compares the soot burn-out performance of a 0.75 Pt—Al₂O₃—OS1 mini-filter under different soot loading conditions. In these experiments a ‘mini-filter’ (NGK cordierite C611, 300 cpsi, 0.3 mm wall thickness, porosity 59%, mean pore size 20-25 um, 44.45 mm round * 152.4 mm long, 0.236 L volume) was coated at a target load of 0.45 g/in3 and 30 gcf (g per ft3) Pt (0.75% Pt). Coated parts and a blank reference were wrapped in mat and loaded in metal retaining sleeves, weighed after mat burn-out (2 h 550° C. in static oven) and loaded into a converter can specially designed to accommodate three mini-filters: 2 coated parts plus 1 blank cordierite as internal reference. The parts were soot loaded on the engine dyno using a Chevrolet 6.5 L diesel engine. Soot loading was performed using either a low load (Mass Air Flow of 21 g/sec) or high load (MAF 63 g/s) and a target filter inlet temperature of 200° C. These two cases represent soot with either a significant SOF loaded under low engine out NOx or low SOF/‘dry’ soot loaded with high engine out NOx. During loading backpressure was constantly monitored using a δP sensor and flow was controlled using a butterfly valve. In all cases, soot-loading rate was ca. 4 g/hour with total loading times of 3-4 hours.

The impact of the loading conditions on subsequent soot burn is again clear and closely approximates the TGA data. Hence under the low load/low NOx loading cycle there is a single low temperature soot combustion event/exotherm at an inlet temperature of only ca. 270° C. Additionally the soot combustion event exhibited a marked decrease in CO₂ peak (ca. 26000 ppm) with close to zero CO slip (a peak value of ca. 500 ppm) compared to the blank filter loaded simultaneously. This decreased CO/CO₂ production was consistent with the marked decrease in the mass of soot burnt for this sample (2.6 g vs 4.0 g for the 2 sister parts loaded simultaneously). This may indicate some continuous soot regeneration during soot loading or the combustion of SOF during loading. In addition it was noted that conversion of NO to NO₂ or N₂O was <5 ppm at all temperatures. Hence it is evident that under the low load condition it was possible to achieve direct soot oxidation catalysis, the process involved is not consistent with the conventional NO₂-assisted mechanism (U.S. Pat. No. 4,902,487).

However these promising data are contrasted with the performance of the same mini filter loaded under the high load condition. In this case the soot combustion characteristic can be seen to contain two features, a small low temperature (ca. 340° C.) and a large high temperature (600° C.) soot exotherm. This profile is very similar in nature to the TGA performance for a catalyst and soot under conditions of loose contact/low contact efficiency. Surprisingly, analysis of CO oxidation performance indicated no loss in emissions function (CO T₅₀=150±5° C.). Hence the loss in soot oxidation activity could not be attributed to catastrophic deactivation. Hence it appears that a factor or factors in the two loading cycles results in manifestly different modes of catalyst to soot contact and thus diametric differences in regeneration efficiency.

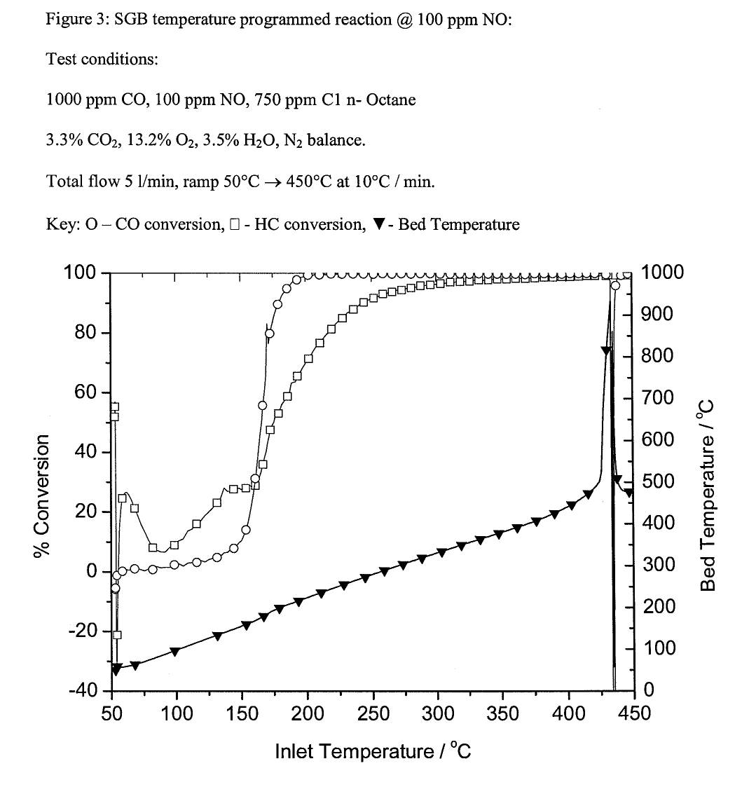

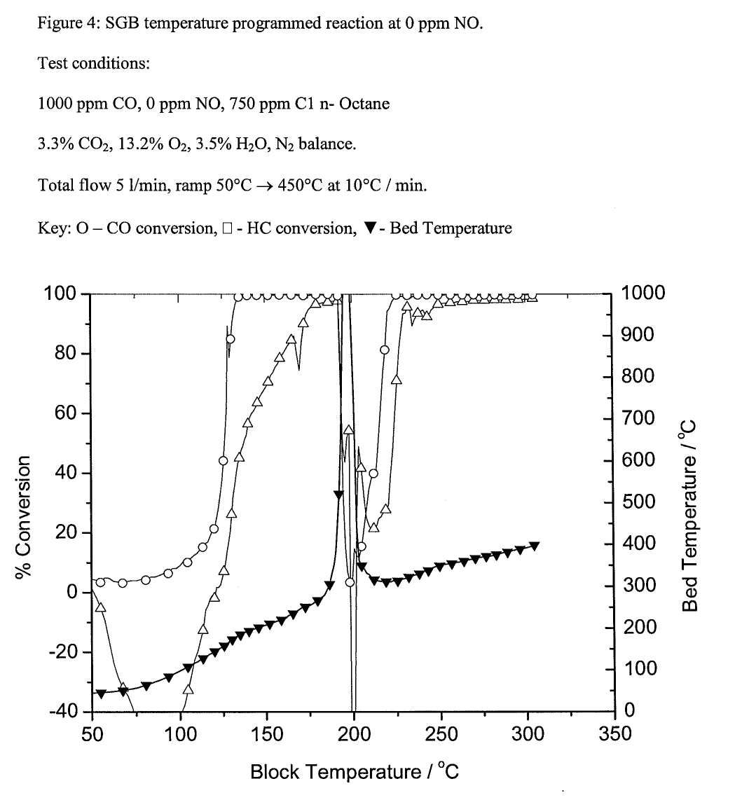

The negative impact of NOx on direct catalyst soot oxidation was next studied (FIGS. 3 and 4) in synthetic gas bench (SGB) studies. In these experiments the reactivity of intimate mixtures of 0.75% Pt—Al₂O₃—OS1: Printex U (4:1) in the presence or absence of NO was examined. In these experiments the catalytic oxidation of CO and HC was found to be unaffected. However, in the presence of 100 ppm NO in the feed soot combustion was found to occur only at temperatures>430° C. This is in marked contrast to the reactivity at 0 ppm NO resulting wherein soot combustion occurred ca 250° C., consistent with the low engine load/low NOx mini filter experiment, thereby confirming the ‘de-coupling’/poisoning impact of NOx on direct catalytic soot oxidation.

Two cubic NOx adsorbers were formulated to evaluate if a Fluorite lattice could be produced having a strontium-based NOx adsorber dispersed therein. The first solid solution comprised the composition: (OS2) 34 mol % CeO₂, 9.5 mol % Nd₂O₃, 4.5 mol % Pr₆O₁₁, 10 mol % SrO, and 42 mol % ZrO₂, and the second solid solution comprised the composition: (OS3) 44 mol % CeO₂, 9.5 mol % Nd₂O₃, 4.5 mol % Pr₆O₁₁, 10 mol % SrO, and 32 mol % ZrO₂.

To produce the samples, the compositions were first dissolved in 500 millilitres (ml) of deionised water. The resulting homogeneous solution was precipitated slowly under vigorous stirring by addition of 1.35 litters (L) of 4 molar (M) ammonium hydroxide (NH₄OH) to form a precipitate of mixed metal hydrous oxides. The reaction mixture was additionally stirred for 3 hours. The precipitate (in the form of powder) was filtered, washed with deionised water, and then dried at about 110° C. for 12 hours. The dried powder was then ground, and calcined at about 700° C. for 6 hours.

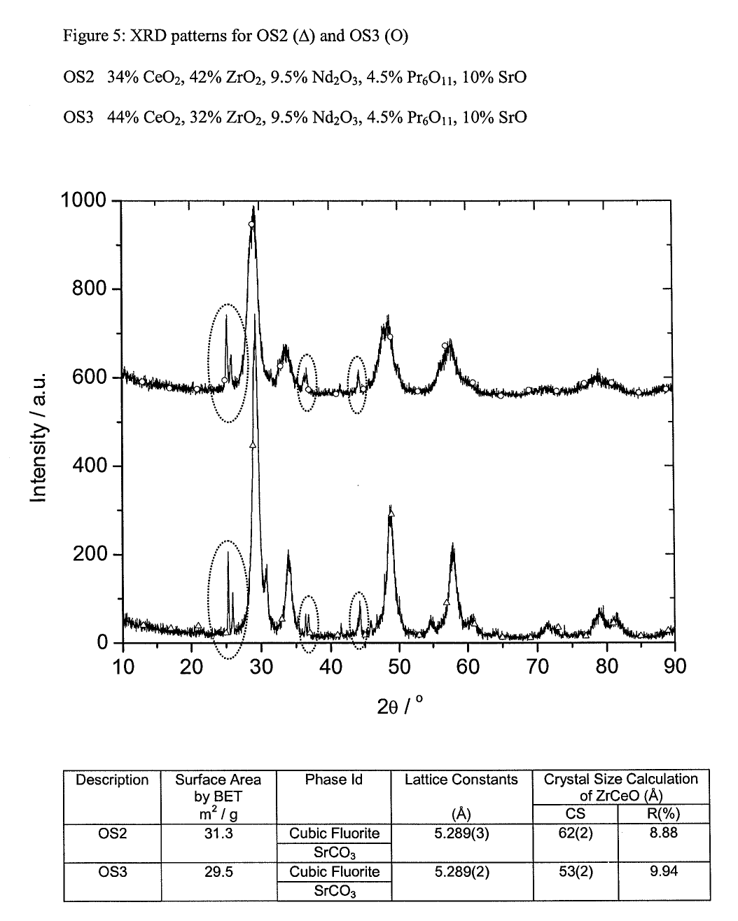

FIG. 5 is a graph of the X-Ray Diffraction patterns of the resulting powders OS2 (□) and OS3 (O). This data confirmed the original syntheses were not successful in incorporating SrO into the Cubic Fluorite lattice due to the formation of a stable and separate SrCO₃ phase.

OS2 34% CeO₂, 42% ZrO₂, 9.5% Nd₂O₃, 4.5% Pr₆O₁₁, 10% SrO

OS3 44% CeO₂, 32% ZrO₂, 9.5% Nd₂O₃, 4.5% Pr₆O₁₁, 10% SrO

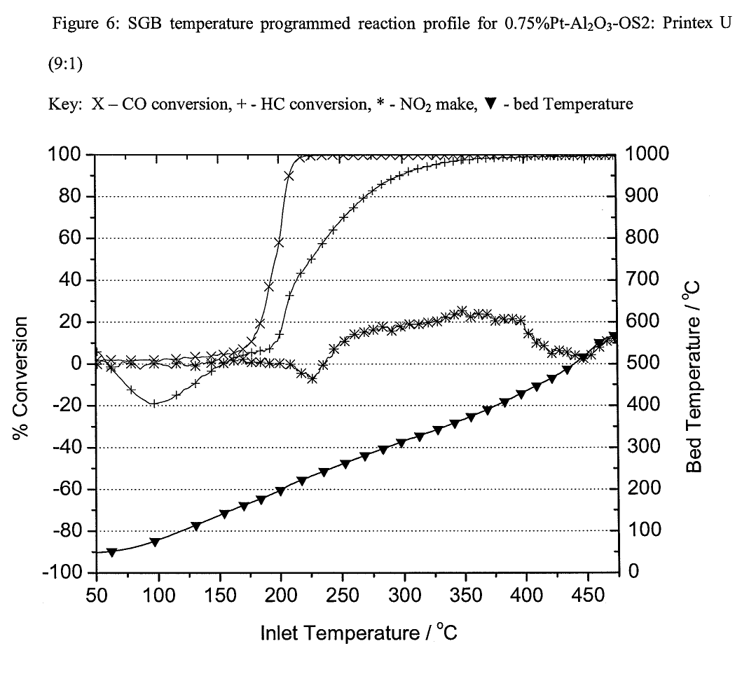

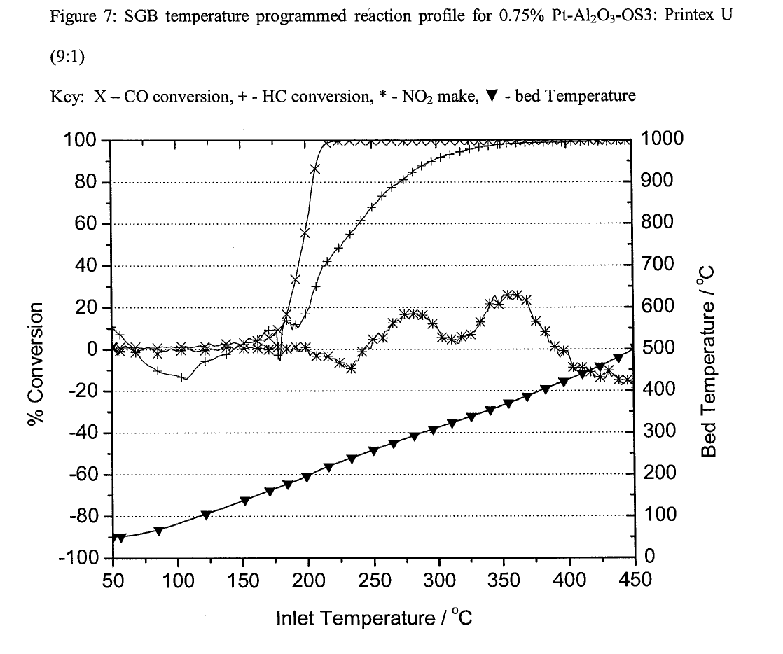

The failure to incorporate the SrO into the lattice was found to result in marked decreases in the activity of the materials due to an inability to scavenge NOx and hence prevent ‘de-coupling’. Thus, in FIGS. 6 and 7, which show the SGB temperature programmed reaction profiles for intimate mixtures of 0.75% Pt—Al₂O₃—OS2: Printex U (9:1) and 0.75% Pt—Al₂O₃—OS3: Printex U (9:1) respectively, both illustrate low NO₂ storage and low or zero soot combustion activity even at temperatures>450° C. These findings are consistent with the hypothesis regarding the negative impact of NO₂ and the ‘de-coupling’ of the catalyst soot contact required for the direct oxidation process.

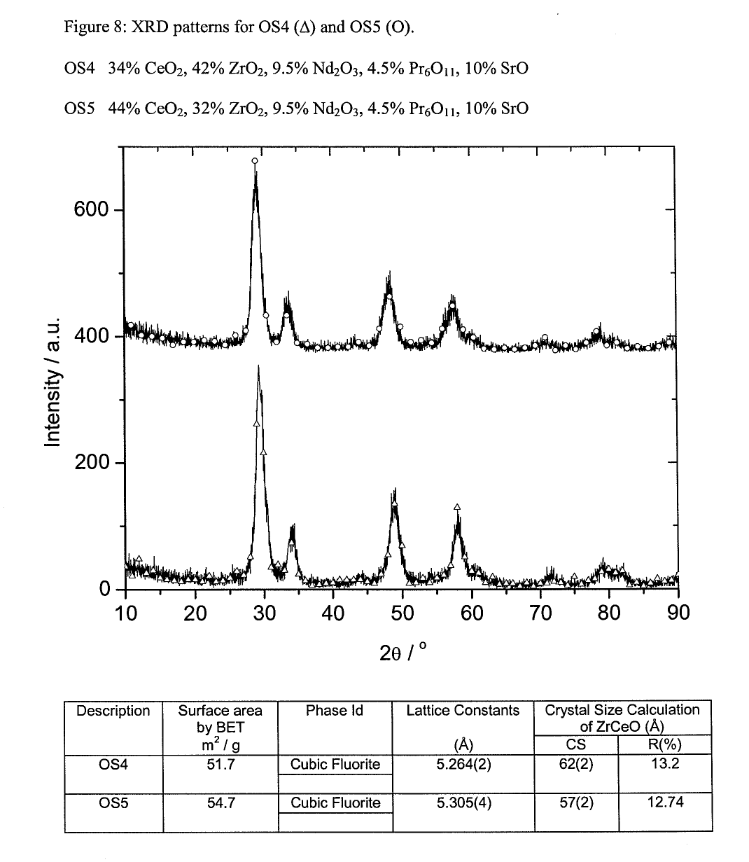

However, upon repetition of the syntheses, taking care to avoid contamination by organics—the combustion of which could be linked to the formation of SrCO₃, a successful result was obtained. Hence, FIG. 8 illustrates the XRD patterns for OS4 (Δ) and OS5 (O) confirming that Sr was incorporated into the Cubic Fluorite lattice.

OS4 34% CeO₂, 42% ZrO₂, 9.5% Nd₂O₃, 4.5% Pr₆O₁₁, 10% SrO

OS5 44% CeO₂, 32% ZrO₂, 9.5% Nd₂O₃, 4.5% Pr₆O₁₁, 10% SrO

Using OS4 and OS5 solid solutions, four diesel NOx traps (DNT) were constructed. The first NOx trap comprised a substrate with 1:1 OS4:Al₂O₃ and 2 wt.% Pt disposed thereon. The second NOx trap comprised a substrate having 1:1 OS4:Al₂O₃ and 2 wt. % Pd disposed thereon. The third NOx trap comprised a substrate having 1:1 OS5:Al₂O₃ and 2 wt. % Pt disposed thereon. The fourth NOx trap comprised a substrate having 1:1 OS5:Al₂O₃ and 2 wt. % Pd disposed thereon. The NOx traps were formed by first preparing a washcoat of the respective solid solution and the respective catalyst (e.g., the OS4 mixed with Al₂O₃ to which 2 wt. % Pt from Platinum nitrate precursor was added). The washcoat was then disposed on cordierite substrates, which were then calcined at about 540° C.

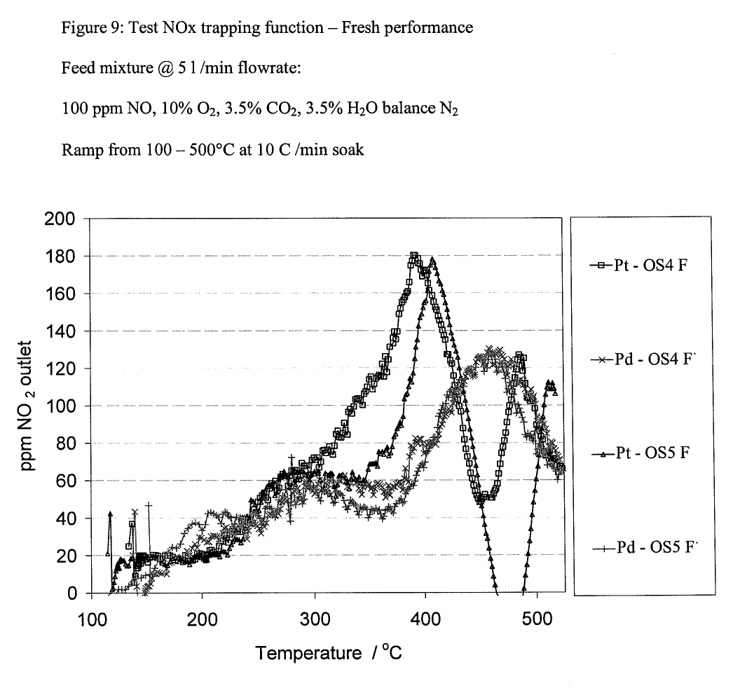

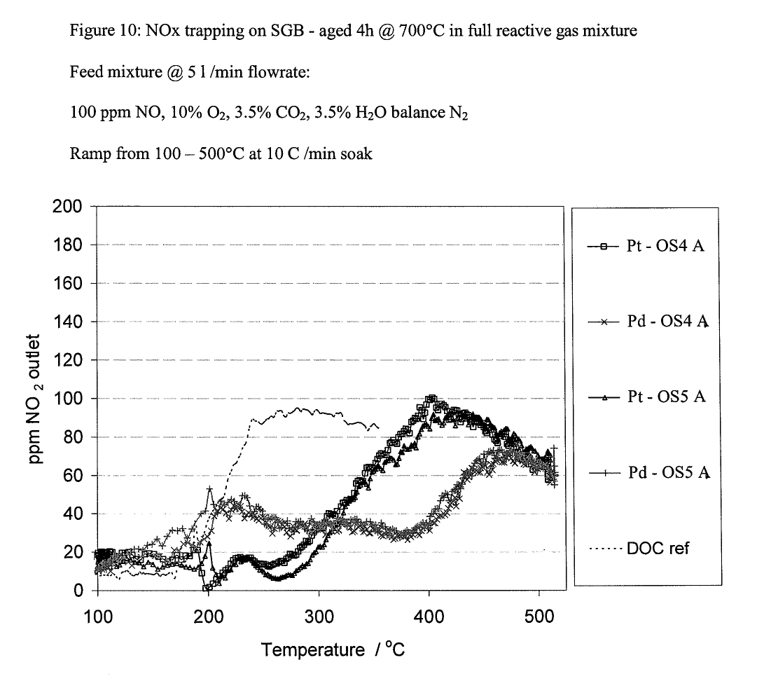

The NOx traps were then individually tested on a diesel testing apparatus wherein an exhaust gas of known composition was passed through the substrate and the NO₂ produced from each substrate was measured with respect to temperature, as illustrated in FIGS. 9 and 10 attached hereto. To be more specific, the exhaust gas passed through the substrates comprised 100 ppm (parts per million) NO, 10 vol. % (volumetric %) O₂, 3.5 vol. % CO₂, 3.5 vol. % H₂O, and the balance being N₂.

As can be generally seen, all of the samples store NOx at lower temperatures, which is evident from the reduced NO₂ production at lower temperatures, and the release of NOx at higher temperatures, which is evident from the increased production of NO₂ at higher temperatures (e.g., 400° C.). However, the amount of NO₂ produced seems to be related to the catalyst employed, as the samples that employed platinum produced a greater concentration of NO₂ than the samples that comprised palladium. In addition, it is noted that the samples that comprised platinum produced NO₂ at a lower temperature (e.g., about 400° C.) than did the samples that comprised palladium, which can indicate platinum is capable of converting NO to NO₂ at a lower temperature than palladium. Therefore, it can be theorized that platinum is capable of converting a greater amount of NO to NO₂ than palladium during operation as the NO released by the NOx adsorber at temperatures below about 400° C. are not converted by palladium, although not bound by theoretical hypotheses.

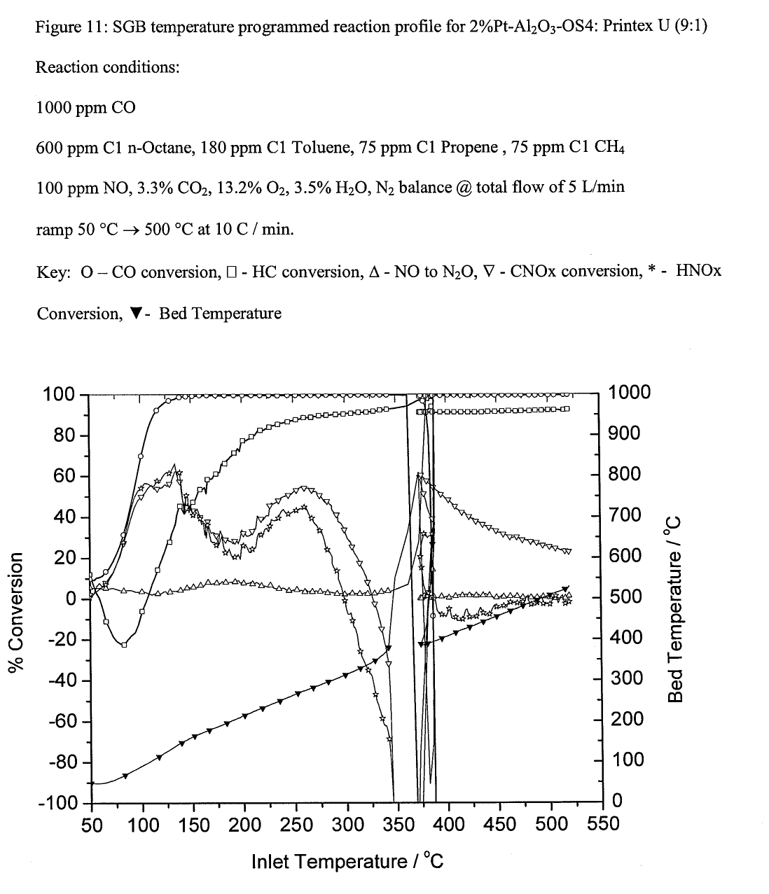

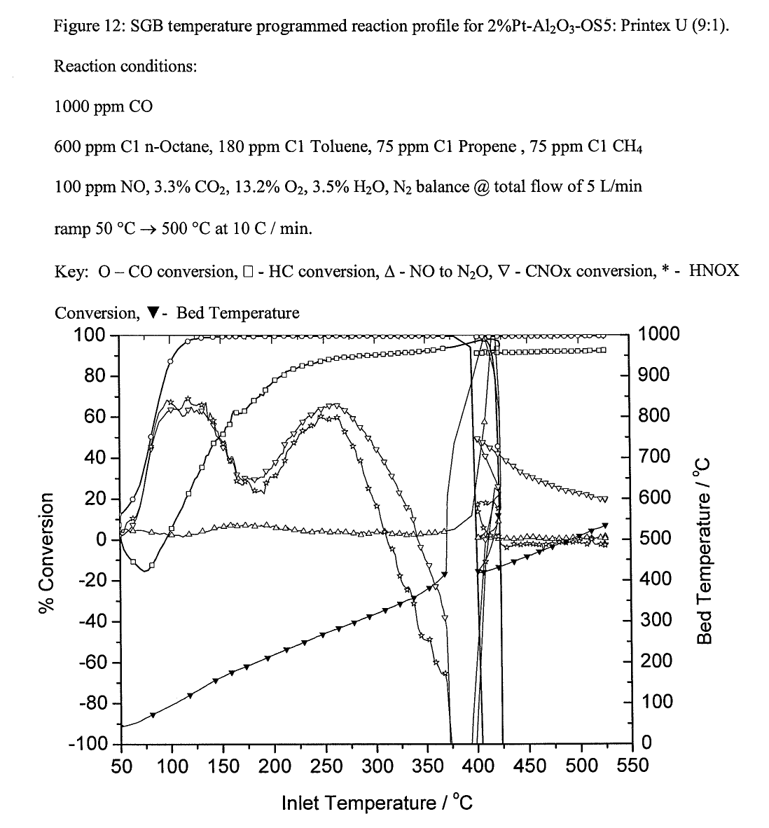

The activity powder samples of the 2% Pt—Al₂O₃—OS4 for the direct oxidation of Printex U soot was then examined giving the result in FIGS. 11 and 12. In both cases the catalyst was intimately mixed the soot material (9 parts catalyst mix: 1 part soot) and transferred to the SGB and a temperature programmed reaction performed using 1 g of sample.

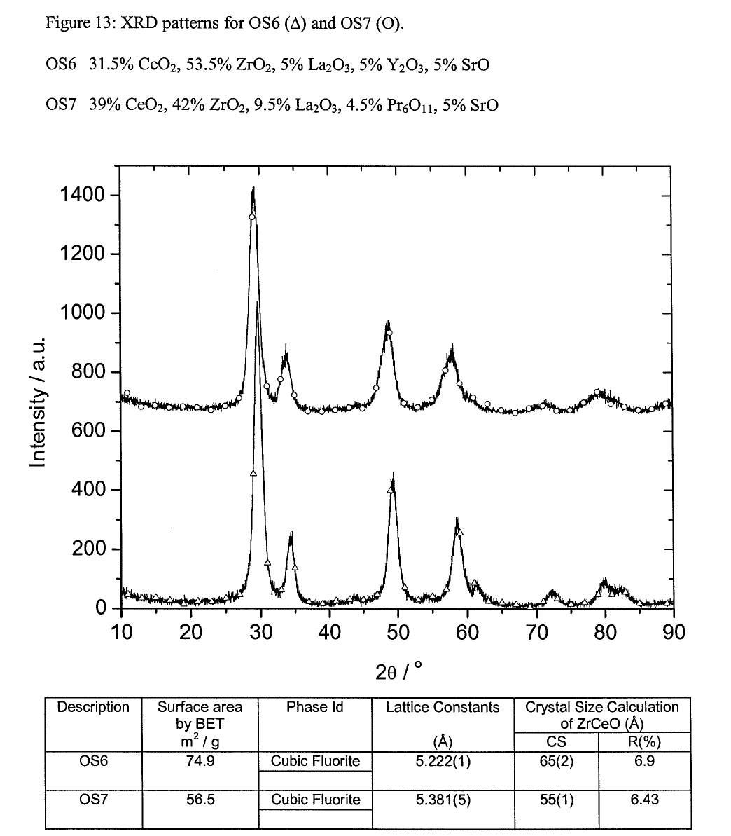

The resulting performance is clearly different from the previous unsuccessful synthesis, both samples exhibit 2 low temperature NOx trapping events with peaks at ca 100 and 250° C. Both also exhibit soot burn events coincident with large bed exotherms at @360 and 380° C. respectively. Coincident with these exotherms/soot burn events, there is a large production of CO resulting in a negative CO conversion. Simultaneously the large bed exotherm results in a large desorption of NOx retained on the composite cubic NOx scavenger. Moreover, coincident with the soot burn event there is a large production of N₂O consistent with the reduction of NOx over Pt under the locally rich (high in CO) conditions. Further syntheses of candidate materials were then undertaken as illustrated in FIG. 13 which records the XRD patterns for OS6 (□) and OS7 (O). Again XRD confirmed the presence of a substantially phase pure Cubic Fluorite phase with the SrO fully incorporated into the Cubic Fluorite lattice.

OS6 31.5% CeO₂, 53.5% ZrO₂, 5% La₂O₃, 5% Y₂O₃, 5% SrO

OS7 39% CeO₂, 42% ZrO₂, 9.5% La₂O₃, 4.5% Pr₆O₁₁, 5% SrO

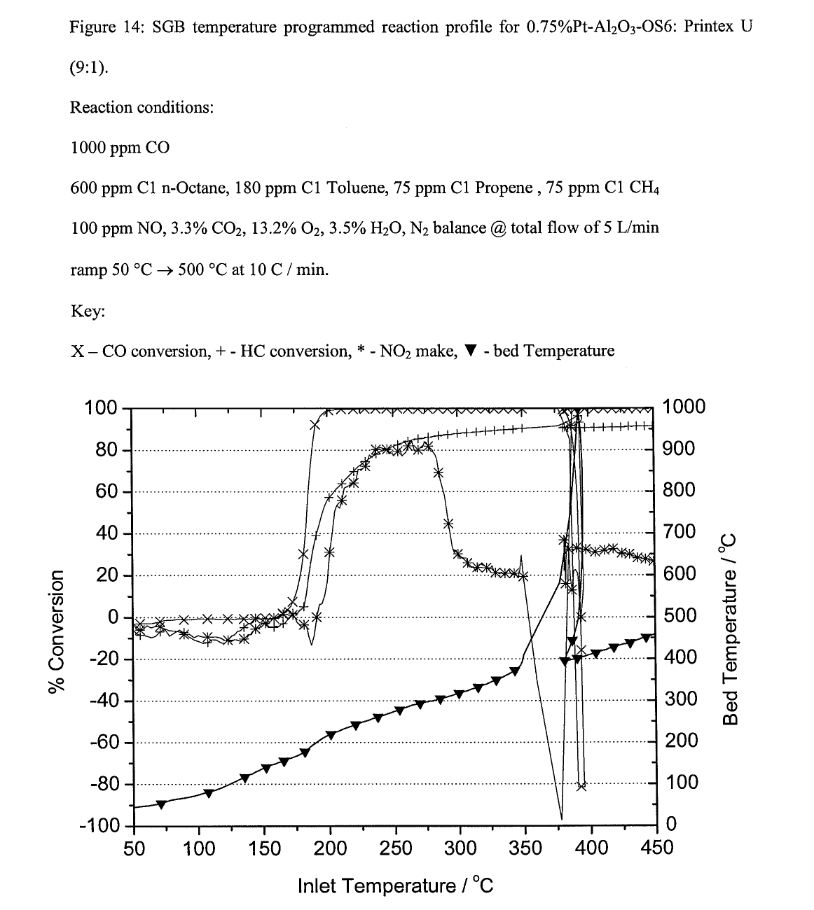

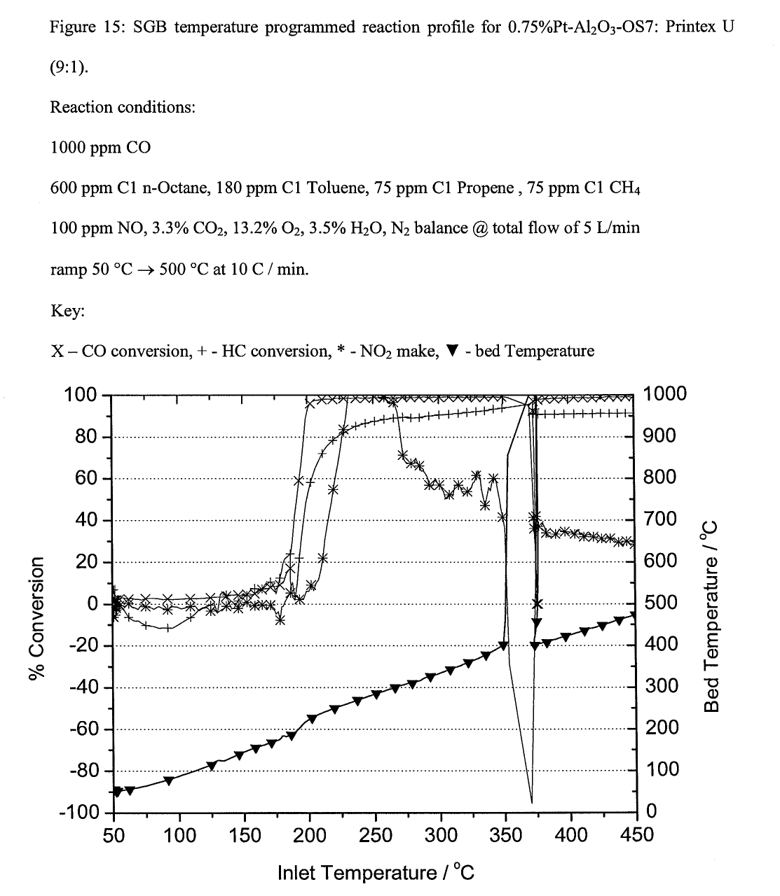

The activity of OS6 and OS7 for direct soot oxidation was again probed using intimate mixtures of catalyst and soot giving the results in FIGS. 14 and 15 for (0.75% Pt—Al₂O₃—OS6: Printex U (9:1) and (0.75% Pt—Al₂O₃—OS7: Printex U (9:1), respectively). Again both materials illustrate enhanced low temperature NO₂ storage which inhibits ‘de-coupling’ and hence, facilitate complete soot combustion at ca. 375° C. and 360° C. respectively. Reaction conditions for both tests were:

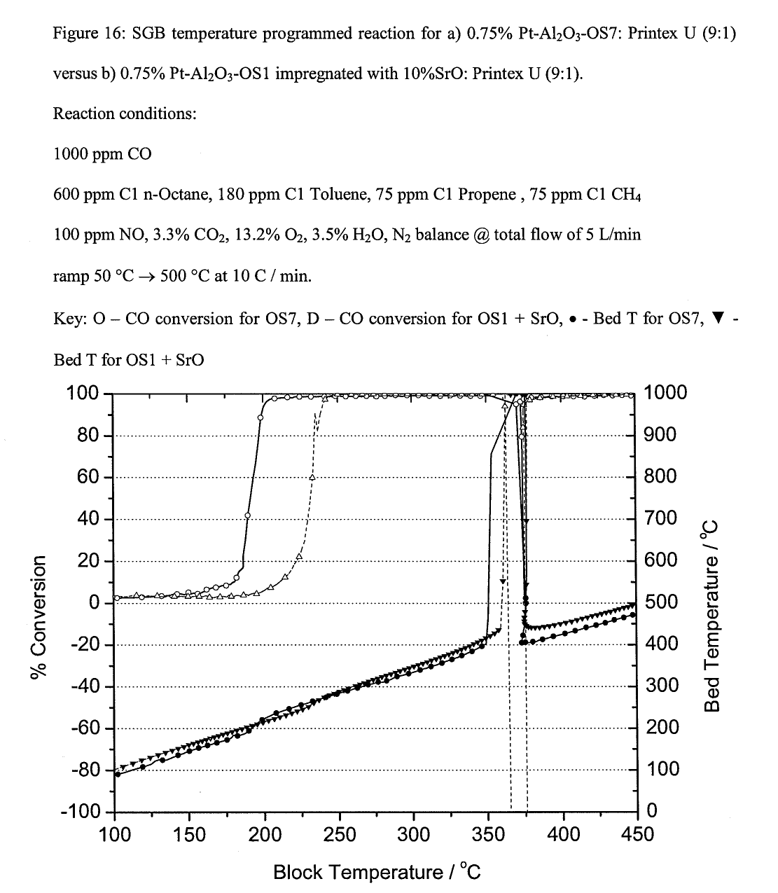

To emphasize the benefit of the composite cubic NOx scavenger the CO, HC and soot combustion performance of an intimate mixture of 0.75% Pt—Al₂O₃—OS7: Printex U (9:1) versus an intimate mixture of 0.75% Pt—Al₂O₃—(OS1 impregnated with 10% SrO by conventional methods): Printex U (9:1) was determined. The activities of the samples are summarized in FIG. 16. In both cases, the SrO scavenges NOx to avoid decoupling and so facilitate low temperature soot combustion. However the performance of OS7 is superior wrt CO light-off (50% CO conversion @192 for OS7 vs 232° C. for OS1+SrO, note a comparable benefit was seen for HC but the data is omitted to assist with clarity of the figure). In addition the use of the OS7 material also exhibited a decrease in the soot combustion temperature (360 vs 375° C.) and a significant benefit with CO slip during soot burn (1000 ppm vs ca. 4000 ppm CO for OS1+SrO). The data confirm the use of the composite material is a novel invention and clearly greater than a simple sum of its parts.

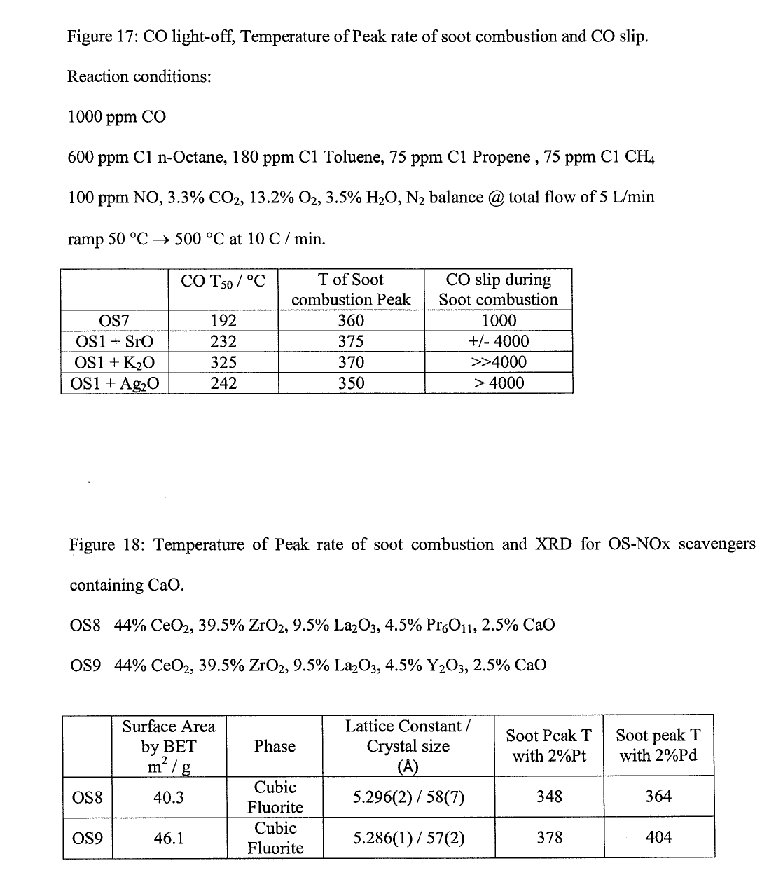

The performance of 0.75% Pt—Al₂O₃—OS7 is further contrasted with conventional NOx trap impregnated systems in FIG. 17. The summary table again confirms benefit for CO light-off, temperature of Peak rate of soot combustion and CO slip during soot combustion characteristics for OS7 versus 0.75% Pt—Al₂O₃—OS+NOx trap systems, for OS1+10% SrO, OS1+10% K₂O or OS1+10Ag₂O.

The use of alternative metal oxides is shown in FIG. 18 which summarises the temperature of Peak rate of soot combustion and XRD characteristics for composite OS—NOx scavengers containing CaO as the NOx trapping component.

OS8 44% CeO₂, 39.5% ZrO₂, 9.5% La₂O₃, 4.5% Pr₆O₁₁, 2.5% CaO

OS9 44% CeO₂, 39.5% ZrO₂, 9.5% La₂O₃, 4.5% Y₂O₃, 2.5% CaO

From the data presented above, it can be established that composite cubic solid solutions produced having strontium oxide or similar oxide NOx scavenger therein can adsorb NOx at low operating temperatures (e.g., below 350° C.) and release NOx at higher operating temperatures (e.g., above 350° C.). Moreover, with the addition of a catalytic metal or metals, the solid solutions can provide added catalytic functions, whereon NO is oxidized to NO₂ fuel-lean operation or, conversely, NOx is chemically converted/reduced to nitrogen under fuel-rich conditions. In addition, the washcoat employed utilized less NOx adsorber (by wt. %) than the barium oxide NOx adsorbers currently employed. This reduces manufacturing cost and backpressure on the system, which provide increased engine performance and efficiency. In addition, as a result of the cubic NOx adsorbers' nature, these NOx adsorbers will exhibit a higher resistance to sulfur poisoning and can be desulfated at a lower temperature than non-lattice based NOx adsorbers. Yet further, the strontium-based NOx adsorber employed does not present the toxicity concerns as compared to barium or potassium oxides.

Unless defined otherwise, technical and scientific terms used herein have the same meaning as is commonly understood by one of skill in the art to which this invention pertains. The terms ‘first’, ‘second’, and the like, as used herein do not denote any order, quantity, or importance, but rather are used to distinguish one element from another. Also, the terms ‘a’ and ‘an’ do not denote a limitation of quantity, but rather denote the presence of at least one of the referenced item, and the terms ‘front’, ‘back’, ‘bottom’, and/or ‘top’, unless otherwise noted, are merely used for convenience of description, and are not limited to any one position or spatial orientation. If ranges are disclosed, the endpoints of all ranges directed to the same component or property are inclusive and independently combinable (e.g., ranges of ‘up to about 25 wt. %, or, more specifically, about 5 wt. % to about 20 wt. %,’ is inclusive of the endpoints and all intermediate values of the ranges of ‘about 5 wt. % to about 25 wt. %,’ etc.). The modifier ‘about’ used in connection with a quantity is inclusive of the stated value and has the meaning dictated by the context (e.g., includes the degree of error associated with measurement of the particular quantity). The suffix ‘(s)’ as used herein is intended to include both the singular and the plural of the term that it modifies, thereby including one or more of that term (e.g., the colorant(s) includes one or more colorants). Furthermore, as used herein, ‘combination’ is inclusive of blends, mixtures, alloys, reaction products, and the like.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

1. A composite mixed oxide OS-NOx scavenger comprising:
a solid solution, wherein the solid solution comprises a substantially single phase crystalline oxide material as determined by conventional X-ray Diffraction methods; and,
a NOx scavenger disposed within the crystalline oxide structure, without formation of additional phase as determined by XRD, wherein the NOx scavenger is formed from oxides of an element selected from the group consisting of alkali metals, alkaline earth metals, rare earth metals, transition metals and mixtures thereof.

2. The composite mixed oxide OS-NOx scavenger of claim 1, which has a cubic fluorite structure and further consists of elements selected from the group consisting of cerium, zirconiurn, thorium and mixtures thereof.

3. The composite mixed oxide OS-NOx scavenger of claim 2, further comprising a stabiliser, wherein the stabiliser is a metal or metal oxide.

4. The composite mixed oxide OS-NOx scavenger of claim 3, wherein the metal is a member selected from the group consisting of scandium (Sc), yttrium (Y), lanthanum (La), cerium (Ce), neodymium (Nd), praseodymium (Pr), neodymium (Nd), promethium (Pm), samarium (Sm), europium (Eu), gadolinium (Gd), terbium (Tb), dysprosium (Dy), holmium (Ho), erbium (Er), thulium (Tm), ytterbium (Yb), lutetium (Lu) and mixtures thereof.

5. The composite mixed oxide OS-NOx scavenger of claim 3, wherein the metal oxide is a rare earth metal oxide.

6. A composite mixed oxide OS-NOx scavenger, comprising
a solid solution, wherein the solid solution comprises a substantially single phase crystalline oxide material as determined by conventional X-ray Diffraction methods; and,
a NOx scavenger disposed within the crystalline oxide structure, without formation of additional phase as determined by XRD, wherein the NOx scavenger is formed from oxides of an element selected from the group consisting of alkali metals, alkaline earth metals, rare earth metals, transition metals and mixtures thereof;
which has a cubic fluorite structure and further consists of elements selected from the group consisting of cerium, zirconium, thorium and mixtures thereof; and
further comprising a catalytic metal selected from the group consisting of platinum, palladium, iridium, silver, rhodium, ruthenium and mixtures thereof.

7. The composite mixed oxide OS-NOx scavenger of claim 2, further comprising a redox active metal oxide.

8. The composite mixed oxide OS-NOx scavenger of claim 2 wherein the redox active metal oxide is ceria, manganese oxide or iron oxide.

9. The composite mixed oxide OS-NOx scavenger of claim 2, wherein the NOx scavenger is capable of forming nitrates at temperatures that are less than or equal to about 200 C. and capable of reducing the nitrates at temperatures that are greater than about 200 C.

10. The composite mixed oxide OS-NOx scavenger of claim 2, wherein the NOx scavenger is capable of forming nitrates at temperatures that are less than or equal to about 300 C. and capable of reducing the nitrates at temperatures that are greater than about 300 C.

11. The composite mixed oxide OS-NOx scavenger of claim 3, wherein the NOx scavenger is capable of forming nitrates at temperatures that are less than or equal to about 400 C and capable of reducing the nitrates at temperatures that are greater than about 400 C.

12. The composite mixed oxide OS-NOx scavenger of claim 6, further comprising a stabilizer, wherein the stabilizer comprises a metal selected from the group consisting of scandium (Sc), yttrium (Y), lanthanum (La), cerium (Ce), praseodymium (Pr), neodymium (Nd), promethium (Pm), samarium (Sm), europium (Eu), gadolinium (Gd), terbium (Tb), dysprosium (Dy), holmium (Ho), erbium (Er), thulium (Tm), ytterbium (Yb), lutetium (Lu) and mixtures thereof.

13. The composite mixed oxide OS-NOx scavenger of claim 6, further comprising a redox active element selected from the group consisting of cerium oxide, cerium-zirconium composite oxide and mixtures thereof.

14. A composite catalyst comprising:
a NOx adsorber comprising:
a) a solid solution, wherein the solid solution comprises a substantially single phase crystalline material as determined by conventional X-Ray Diffraction methods; and,
b) a NOx scavenger disposed within the single phase crystalline structure, without formation of additional phase as determined by XRD, wherein the NOx scavenger if formed from oxides of an element selected from the group consisting of alkali metals, alkaline earth metals, transition metals and mixtures thereof; and
a platinum group metal deposited on said composite cubic OS-NOx scavenger.

15. The composite catalyst of claim 14, wherein the single phase crystalline structure has a cubic fluorite structure and comprises a material selected form the group consisting of ceria, zirconia, thoria and mixtures thereof.

16. The composite catalyst of claim 14, further comprising a stabiliser, wherein the stabiliser is a metal or metal oxide.

17. The composite catalyst of claim 16, wherein the metal is selected from a group consisting of scandium (Sc), yttrium (Y), lanthanum (La), cerium (Ce), praseodymium (Pr), neodymium (Nd), promethium (Pm), samarium (Sm), europium (Eu), gadolinium (Gd), terbium (in), dysprosium (Dy), holmium (Ho), erbium (Er), thulium (Tm), ytterbium (Yb), lutetium (Lu) and mixtures thereof.

18. The composite catalyst of claim 16, wherein the metal oxide is a rare earth metal oxide.

19. The composite catalyst of claim 14, wherein the platinum group metal is selected from the group consisting of platinum, palladium, iridium, silver, rhodium, ruthenium and mixtures thereof.

20. The composite catalyst of claim 14, having oxygen storage and release properties.

21. The composite catalyst of claim 19 which can undergo reversible oxidation (reduction) under conditions in an exhaust environment.

22. The composite catalyst of claim 14, wherein the NOx scavenger is capable of forming nitrates at temperatures that are less than or equal to about 200 C. and capable of reducing the nitrates at temperatures that are greater than about 200 C.

23. The composite catalyst of claim 14, wherein the NOx scavenger is capable of forming nitrates at temperatures that are less than or equal to about 300 C. and capable of reducing the nitrates at temperatures that are greater than about 300 C.

24. The composite catalyst of claim 14, wherein the NOx scavenger is capable of forming nitrates at temperatures that are less than or equal to about 400 C. and capable of reducing the nitrates at temperatures that are greater than about 400 C.

25. An exhaust gas treatment catalyst comprising the composite catalyst of claim 13, deposited on an inert substrate.

26. A method of treating exhaust gas comprising passing an exhaust gas over the composite catalyst of claim 13.
